(19) United States
(12) Patent Application Publication
(10) Pub. No.: US 2010/0206891 A1
(43) Pub. Date: Aug. 19, 2010

(54) CAN BODY AND PROCESS AND DEVICE FOR PRODUCING IT

(76) Inventor: Werner Boltshauser, Butschwil (CH)

Correspondence Address: HARNESS, DICKEY & PIERCE, P.L.C., P.O. BOX 8910, RESTON, VA, 20195, US

(21) Appl. No.: 12/452,799

(22) PCT Filed: Jun. 25, 2008
(86) PCT No.: PCT/CH2008/000287

§ 371 Date: Mar. 18, 2010

(30) Foreign Application Priority Data
Jul. 27, 2007 (CH) 1202/07

(51) Int. Cl. B65D 1/42; B23P 17/04; B21D 51/30; B21D 51/46

(52) U.S. Cl. 220/658; 29/428; 29/213.1; 413/2; 413/26; 413/62

(57) ABSTRACT

In at least one embodiment, an inward edge flange with an inserted sealing ring is arranged in the form of a valve seat at the free end of a constricted can neck on a can body. The inward edge flange holds the sealing ring without completely surrounding it, and the sealing ring is therefore accessible from the interior of the can lateral surface. After the crimping of a valve part, an inner stop is formed between the sealing ring and the connecting shell flange. Since the sealing ring is elastic, the connecting shell flange bears against the sealing ring without gaps along the entire circumference. The sealing ring also bears tightly against an inner contact surface of the inward edge flange of the can body.

The invention relates to a can body referring to the preamble of claim 1, and to a method for production of can bodies referring to the preamble of claim 9, and to a device for production of can bodies referring to the preamble of claim 15.

Aerosol can bodies are designed from one or several parts. In case of one-piece aerosol aluminum cans, a cylindrical can body is prepared by cold extrusion. Afterwards, a valve seat is created by compression necking at the open end. This production method is very complex due to the machine needed because of the many production steps and due to the water and energy need for cleaning and drying. U.S. Pat. No. 4,095,544 and EP 0 666 124 A1 describe the production of seamless steel cans. Hereby, the cylindrical can body is produced from a tin or plastic coated steel plate by blanking, pressing and wall ironing. It has been shown that enormous problems occur during the production of the constricted can neck, since the structure of the material is altered or hardened by the wall ironing.

Also can bodies from steel plates, wherein the jacket exhibits a longitudinal welding seam, are widely spread. The bottom and the upper lid are fixed to the jacket by folded joints. In folded joints, sealing problems can occur which can be reduced, for example, by sealing rings. Problems occur with sealings located at the front end side in case of the current extremely thin walled cans.

From U.S. Pat. No. 4,753,364 an aerosol can is known wherein the can body is produced from a flat rectangular plate. The plate is shaped to a cylindrical jacket having a circular cross section. Both matching side edges are butt welded creating a cylindrical can jacket having an essentially constant wall thickness. After putting the can jacket onto an arbor having a dome-shaped end area, the can jacket is pressed to the dome-shaped end area in several constricting steps. A cylindrical section having a smaller diameter reaches from the dome-shaped constricted area to the open end of the shaped can jacket.

A precise edge is created by a cutting step at the constricted end. Afterwards, the cylindrical section having a smaller cross section is shaped as a valve seat by an inward curl. The curl is formed in such a way that the cut front is located at the inner face of the curl. The connecting bowl curl of a valve part placed on the valve seat does neither encounter the cut front of the can jacket nor the excavation within the curl. The fixation of the connecting bowl onto the inward curl corresponds to the widely spread fixation of the connection bowl onto an outward curl wherein, however, the product within the can is able to get to the cut front end in the excavation of the valve seat which is not desired in many products.

From WO05/000498, a solution is known wherein a can bottom is attached to a can jacket closed by a butted longitudinal laser seam, at the lower front end by a laser seam. A constriction is formed at the upper front end. For that purpose, a forming roll is pressed to the rotating can jacket from the outside. In the inside of the can jacket a backing edge is placed which acts together with the forming roll during the constriction process and is moved in the direction of the upper front end. An upper lid element containing a valve seat is welded to the constricted upper end of the can jacket. If applicable, the upper end of the can jacket is constricted by compression-necking or spin-flow-necking wherein this constriction can be realized up to the creation of the valve seat. The valve seat is created by the can end being shaped to the outside wherein the valve seat is essentially circular in a cross section comprising the longitudinal can axis. The open end reaches from the inside to the outside and from the outside back to the outer surface of the constricted can jacket. The valve seat concerns a so called outward-curl or outward edge curl.

From WO05/068127, a solution is known wherein a can jacket having a longitudinal butted laser seam is pressed radially to the outside onto an inner mold for forming. A can bottom is welded to the can jacket at the lower front end. At the upper front end an upper lid element having a valve seat is placed by a laser seam. If applicable, a constriction method, for example compression-necking or spin-flow-necking, is conducted instead of the upper lid element at the upper front end of the can jacket. This constriction can be realized up to the creation of the valve seat. The represented embodiments show outward curls or outward edge curls.

To fasten valves to aerosol can bodies, a connecting bowl curl with the valve is crimped to the valve seat. If the valve seat is created by constriction and shaping of the can jacket, fissures can occur at the valve seat which leads to unwanted micro leakages after crimping of the connecting bowls.

U.S. Pat. No. 4,832,326 represents a sealing arrangement between valve seat or outward edge curls of the can body and the valve connecting bowl or connecting bowl crimping of the valve part. The sealing material used within the central contact area has to be applied to the connecting bowl and comprises a desired thickness along the complete circumference. In addition, the connecting bowl has to be crimped exactly right during the crimping process to achieve the desired seal effect and not to damage the sealing material. A defined local change of radius has to be created at the connecting bowl. The production of valve bowls coated with sealing material is complex. If gaskets are inserted, the correct insertion of the valve is difficult.

DE 198 15 638 shows a sealing arrangement for pressurized dispensing cases. A first gasket is arranged between valve bowl and can case. A second gasket is arranged between the valve body lying below the valve bowl and the can case. This solution is not suited for standard aerosol cans, since there is no receiving area for the first gasket. Besides, the layout of the valve is exceedingly complicated.

It is an object to the present invention to provide a solution to produce leakproof cans in a simple and cost-effective way. In particular, the product within the can should not come in contact with the metal layer of the can body.

The object is fulfilled as stated in claim 1, claim 9 and claim 15. The depending claims describe preferred or alternative embodiments.

In solving the object it has been recognized that elastic gasket between valve seat and valve connecting bowl allow a small clearance after crimping between valve seat and connecting bowl of the valve.

The inner pressure pushes the connecting bowl away from the inner part of the can which tends to result in an enlargement of the gasket area between outward edge curl of the can and connecting bowl curl of the valve part. If the area of the connection bowl, which due to the inner pressure is pressed against the outward edge curl of the can body, does not close tightly with respect to the outward edge curl, there is the danger of leakage. The danger of leakage results from an inner stop unit created between connecting bowl and the can body after crimping of a connection bowl curl to the edge curl of the can body whose parts are not elastic and hence, as the case may be, do not close without gap along the complete circumference.

According to the present invention, an inward edge curl having an annular gasket or gasket ring is formed as a valve seat at the can body at the open end being constricted. The inward edge curl keeps the gasket or the sealing ring without enclosing it so that it is accessible from the inner side of the can jacket. After crimping of a valve part an inner stop unit between gasket ring and connection bowl curl is created. Since the gasket ring is elastic, the connection bowl curl engages the entire circumference to the gasket ring without a gap. The gasket ring also engages tightly to an inner contact face of the inward edge curl of the can body.

Since the inner pressure of the can affects also directly on the gasket ring via the connection bowl, the danger of leakage is diminished by the inner pressure. The inner pressure enhances the pressure force between inner contact face of the connection bowl and the gasket ring as well as between gasket ring and inward edge curl of the can body.

If necessary, a fixed connection between tightly engaging contact faces of the gasket ring and the inner coating of the can body as well as the connection bowl is established by a thermal treatment and/or a coating by a sealing material. As the case may be, a cursory contact layer of the gasket ring melts and joints with the adjacent contact face. If a sealing coating is used, it is advantageous to arrange it at the gasket ring. To create the sealing connection at the right time, namely after correctly assembling the components, preferably a hot sealing material is used.

Since the gasket ring of the valve seat takes over the sealing function, connecting bowls without sealing material can be used. The inward edge curl just has to retain the gasket ring but not enclose it. It is arranged in a way that is open to the inner of the can body in a c-shaped manner in a cross section that comprises the can longitudinal axis so that the gasket ring is accessible from the inner side of the can body along its complete circumference. The forming expense for the inward edge curl is smaller compared to the closed edge curl.

The can neck can be produced as a separate part and be connected to the can jacket by a welding or folding connection. Preferably, the can neck is created by a constriction method, especially spin-flow-necking, at one of the front ends of the can jacket.

Since in case of small can diameters the constriction at the neck is small, it can be achieved with small effort by means of a constriction method. In case of large can diameters the constriction has to be executed until the usual valve diameter is reached. To do without the corresponding extreme constriction of the neck sector, it is often appropriate to attach a separate part having an inward edge curl and a gasket to the can jacket.

It goes without saying that the gasket can also be retained within the inward edge curl by adhesion or gluing forces. Further, in case of embodiments having a valve seat, which is connected to the can jacket by a welded or folded joint, it is advantageous if the gasket including the inner coating of the part having the valve seat is essentially shaped as one piece. For this, for example, the gasket and the inner coating are affixed in one injection molding step at the inside of the part.

According to a preferred embodiment, the can jacket and the connecting bowl comprise a metal layer, especially iron or steel sheet, and on the inside of the can jacket and the connecting bowl a plastic layer. The plastic layers of the can jacket and the connecting bowl extend to or under the gasket ring so that, viewed from the inside, even in the connecting area between can jacket and connecting bowl a continuous inner coating is ensured.

A connection from gasket ring to the inner coatings of the can jacket and the connection bowl can be attained at the contact surfaces by a small effort. As the case may be a superficial contact layer of the gasket ring melts and connects with the inner coatings. If at the adjacent contact areas a meltable plastic material is placed, the adjacent contact areas fuse due to the thermal treatment. If a seal coating is applied, it is advantageous to place it at the gasket ring. To create the seal connection at the right time, which is the time after the right assembling of the components, preferably a hot sealing material is used.

Another preferred embodiment is the arrangement of a decor in form of a closed foil bowl on the outside of the can jacket.

Especially advantageous and also inventive—independently from the independent claims of the claimed object—is the arrangement of an inner and/or outer foil at the closed cylinder bowl from sheet metal by a pressure arbor and a inner mold. To be able to bring the layers of the can jacket together by a small effort, the pooling is executed using a pressure arbor and a cylindrical inner mold. In the process, the inner foil is closed to form a cylindrical bowl, and put onto the pressure arbor in a way that the arbor is tightly enclosed. Afterwards, the cylinder bowl of metal sheet is put on which now encloses the inner foil. At last, the outer foil is closed to form a cylindrical bowl and put onto the outside of the metal cylinder bowl in an enclosing way. It goes without saying that if necessary even only the inner foil or only the outer foil can be implemented.

The pressure arbor, having the layers of the can jacket arranged to it, is stretched radially within the cylindrical inner mould to the outside. Preferably, an elastic pressure arbor is used which is stretched by means of a pressure fluid placed within the pressure arbor. To achieve pressing from the middle to the front ends, a barrel-shaped arbor can be used, which during pressurizing firstly presses in the middle area. The circumference of all layers of the can jacket is increased somehow during pressing against the inner mold.

To ensure durable adhesion of the foils to the metal layer, foils having a seal layer adjacent to the metal layer are used. In case of a hot sealing layer, the desired sealing is attained by conveying heat to the layers of the can jacket, especially as direct-contact heat from the inner mold, if applicable, even inductively, so that the necessary sealing temperature is guaranteed during a certain time.

The layers, composed by means of sealing connections of the cylindrical can jacket, adhere to such a great extent to each other, that the creation of a can neck and an inward curl by means of a constriction method at the open end of the cylindrical can jacket is possible without any difficulty. In doing so, the inner and outer layer are not damaged but merely shaped together with the metallic layer. The can neck together with the constriction cylindrical end area is for example created by Spin-Flow-Necking. It goes without saying, that even another constriction method known from the prior art is possible.

To be able to position a gasket ring at the open end of a can neck, an inner hub or a ring-shaped stop face at the constricted cylindrical end area is created up to which or in which a gasket ring can be placed. The ring-shaped stop face can be attained by a constriction step below the stop face or by expanding from the open end up to the stop face. After inserting the gasket ring the open end of the can neck merely has to be shaped radially around the gasket ring to the inside, so that the gasket ring is held in a fixed position at the can jacket. The inward curl creates the valves seat together with the inserted gasket ring.

To attach a lid part being positioned at the face side of the can wall, solutions are known from the prior art in which a tight ring-shaped closed welding seam is created by a laser welding seam. It has become evident that for those continuous laser welding seams the adjacent contact areas of the parts to be connected should not be coated or contaminated. Otherwise, the danger exists, that parts of the contamination or coating pass explosively into a gaseous state due to the great heat evolving in the seam area and thereby create cavities within the seam and hence leaky spots. To overcome this disadvantage, it becomes an object for arbitrary cans to find a connection for which no disturbance is created by small contaminations or coatings.

In solving this object, in a first step it has been recognized that the metallic layer of the can jacket, the metallic layer of the lid part and the laser connection between those layers only have to guarantee stability of the can. The leak-tightness can be attained by a continuous inner coating or plastic material within the laser connection, wherein the plastic material is connected tightly with the inner coatings of the parts.

In a second step, it has been recognized that a laser connection having several interruptions along the connection line or by a plurality of narrow areas wherein the laser beam has molten both metallic layers together induces less heat and greatly decreases the danger of explosive gas evolution.

This solution having a plurality of narrow metallic connection spots and sealing plastic material is also new and inventive independently from the independent claims. It can be advantageously applied for all can jackets and lid elements having a metallic layer and is thereby not limited to aerosol cans and, of course, not to special aerosol cans having an inward edge curl, too.

Another advantage of such a circular laser connection having several narrow connection spots consists in that, that it can be conducted by means of a laser scanner device. This means the laser beam is lead for example by mirror movements along the connection line, wherein the laser is alternately let pass through or intercepted, thus creating corresponding connections and interruptions. Due to the scan possibility it can be dispensed with the turning of the can at the laser outlet. Furthermore, the laser output head does not need to be moved along the connection line.

If the can neck or the valve seat of an aerosol can are produced as a separate part and after this are connected to a constriction can jacket, according to a preferred embodiment the welding connection is accomplished having interrupted welding areas in peripheral direction especially having point-shaped welding areas.

Such an interrupted welding connection can also be advantageously implemented to fasten the can bottom to the can jacket. The can bottom can be pressed from the can's inside to a constriction end area of the can jacket and then be fastened overlappingly by an intermittent laser connection at the constricted area. If now, for example, there is no access at the end of the can jacket opposite from the can bottom to put a can bottom into the inner of the can jacket and then to the desired fastening area, there is a possibility to directly take a can bottom at its fastening area through the constriction into the inside of the can jacket.

Since the radius of the can bottom is larger than the radius of the opening at the constricted fastening area of the can bottom, the round cross section of the can jacket at the fastening area of the can bottom is shaped by some pressure or by means of squeezing into an oval free cross section. In doing so, the opening cross section in a first direction increases and decreases in a second direction orthogonal to the first. If now the can bottom is tilted to the plane of the oval opening, it can be inserted into the inside of the can jacket and, after insertion and tilting back, can be pressed from the inside to the direction of the constriction. Within the overlapping area the can bottom can be attached to the can jacket by a laser connection having interruptions. By ring or disk-shaped plastic material on the inside along the laser connection, a continuous and tight inner coating can be attained.

In case of longitudinal seams the heat peak, flowing with the seam generation at the end of the material, leads to unwanted frazzling, where it cannot continue flowing in longitudinal direction. This problem does not occur if long continuous longitudinal seams are created and the can jackets are cut from the becoming pipe. It has been shown, that the problem in production of can jackets from bowl cuts or tablets can also be solved by creating a laser connection having several interruptions along the connection line instead of a continuous laser seam. The interruptions prevent the flow of a heat quantity and, by this, heat transfer problems at the end of a connection or a bowl cut are eliminated. Such a can jacket's longitudinal connection comprises a plurality of closely limited areas, wherein the laser beam has fused both overlapping metallic layers together. If the material of the can jacket is coated on the inside and a continuous inner coating of the can jacket is desired, plastic material is arranged on the inside of the can along the longitudinal seam and is tightly connected with the inner coating on both sides of the seam.

According to another preferred—and independently of the invention claimed in the independent claims—inventive embodiment the can jacket having a formed valve seat is shaped by a second radially expanding compression step to a second inner mold, wherein the second inner mold preferably conforms to a desired end shape of the can jacket. The inner mold can have arbitrary shapes and decor structures differing from the cylindrical shape. In doing so, the valve seat and, by this, the can jacket is kept within the inner mold during pressing. The valve seat is not expanded. By maintaining the can jacket at the valve seat, a defined position of the can jacket relative to the second inner mold is guaranteed. An elastic pressure-chargeable pressure arbor is inserted into the can jacket for pressurizing.

During shaping, a form can be created within a second inner mold at the free end of the can jacket, being opposite of the valve seat, which corresponds to the connecting area of a can bottom. Afterwards, the can bottom is attached to the can jacket by a laser weld seam.

According to another—independently of the claimed invention within the independent claims—inventive embodiment, the free end of the can jacket associated to the can bottom is, if applicable, attached to its outer shape after inserting the can bottom. The approach is possible for all cans, wherein a can jacket is connected to a can bottom during production. To constrict the can end after insertion of the can bottom, preferably a rolling method is used. Thereby, a turning roll is moved relative to the can jacket along its circumference. At the inserted and kept can bottom, and preferably even at the forming roll, the desired constriction contour for the constricted area of the can jacket is created. During rolling, the can jacket is tightly pressed to the contact area of the can bottom. By means of an optimal rolling procedure wrinkling during constriction can be avoided. The wall material is stretched somehow in the direction of the can axis, so that within the constricted area no increase of the wall thickness is necessary. The constriction of the can jacket by pressing to a shoulder-shaped contact area of the can bottom is without any problems, since the constriction needed for the connection is very small.

The front face of the can bottom is located on the inside or at the interior of the can and the front face of the can jacket is located at the outside of the can jacket or outer can side. If the outer face of the can jacket is furnished with a decor, the decor ranges substantially over to the base. Hence, the can is aesthetically especially appealing and is silhouetted against cans, not being furnished with a decor at the bend area of a cylindrical bowl to the can bottom.

In order to position the shoulder-shaped areas of the can bottom and the can jacket fit to each other, wherein the cross-section decreases in the direction of the front side of the can jacket, completely tight to each other, the can bottom, lying on the inside, can possibly be moved a little bit along the can axis to the outside, wherein the adjacent area of the can jacket is minimally expanded and thereby set into tight contact with the can bottom. Within the area of this tight contact, an annularly closed laser weld seam between can jacket and can bottom can be created.

It has become obvious, that a laser weld seam directly at the front side or at the front face of the can jacket is advantageous. With little effort it can be ensured, that metallic areas, preferably without any plastic coating, are allocated to each other. The front face of the can jacket is free from any coating. The outside of the can bottom can be created without any coating, too. If necessary, a metallic powder is applied at the front side, which creates a connection of front face of the can jacket and can bottom during laser welding. To obviate corrosion of the bottom, the bottom can be coated after creation of the laser circumferential seam or be covered by a outer bottom cover.

Within the framework of the invention it has been recognized, that a circumferential laser seam between overlapping areas of can bottom and can jacket, especially at the front side of the can jacket, does not necessarily have to be tight. The circumferential laser seam preferentially performs the task to connect the can jacket with the can bottom in a stable way. Even for the needed can inner pressure in aerosol cans the seam must not burst. It has been shown, that a stable connection, which however is not surely tight, is attained by a clearly smaller effort than an absolutely tight circumferential laser seam. This is due to the circumferential laser seam being extremely narrow, for example substantially 0.15 mm. If now a small contamination exists at one of the parts to be connected within the area of the seam, an explosive vaporization of contamination parts during the fusion occurs, especially of grease and oil fractions. At these positions small interception within the circumferential laser seam can occur.

Since can bottoms preferably are produced at different production sites, possibly in a production or forming process using lubricants, contaminations from production or transport can hardly be eliminated with an justifiable effort. But with a smaller effort it is possible to implement a barrier on the inside of the can between can bottom and can jacket, which tightly seals the inside of the can at the laser weld seam to the outside. Since the possibly leaky spots of the circumferential laser seam are extremely small passage spots, the barrier does not have to absorb high forces.

To be able to provide a tight barrier with small effort between can jacket and can bottom within the area of a circumferential laser seam or a laser connection having several narrow connection spots, according to another preferred and inventive embodiment—also independent of the claimed invention in the independent claims—on the inside of the can along the complete circular circumferential laser seam or laser connection plastic material is arranged, which is tightly connected to the can bottom and the can jacket. Thereby an access from the inside of the can to the circumferential laser seam or laser connection is excluded. The circumferential laser seam or laser connection guarantees the stability needed and the plastic material connected to bottom and can jacket guarantees the tightness.

The plastic material along the circumferential laser seam can be build up at the can bottom as a ring or plate having a ring-shaped edge being laid onto the can bottom, be sprayed by a nozzle or even in an injection molding step. Before or after the creation of the circumferential laser seam, a tight connection of the ring to the can jacket or, if necessary, to the can bottom on both sides of the circumferential laser seam is attained by a heat treatment step.

The sealing plastic material along the circumferential laser seam between can bottom and can jacket is especially advantageously implementable, if the can jacket exhibits a plastic layer on the inside in from of a coating or, preferred, a foil. A can bottom having a plastic layer allocated to the inside of the can, which protrudes along the radially outer edge to the inside of the can or up over the metal edge area of the can bottom, can be inserted into the cylindrical can jacket having a plastic inner layer. After inserting a radial outer contact area of the plastic layer engages the inner layer of the can jacket.

If the can jacket is somewhat constricted in the end area where the can bottom is placed, the can bottom has a slightly larger outer radius than the opening of the constricted area. If the round cross section of the can jacket at the fastening area of the can bottom is formed into an oval cross section by a little pressure or by means of squeezing, the opening cross section increases in one first direction and decreases in an second orthogonal direction. The can bottom is slightly tilted to the plane of the oval opening around an axis, substantially parallel to the first direction, and then inserted into the inside of the can jacket. After insertion, it is tilted back and pressed to the constriction from the inside. In the overlapping area the can bottom can be attached to the can jacket by a laser connection. By ring or disc-shaped plastic material on the inside along the laser connection, a continuous and tight inner coating can be attained.

As already described above, the end area of the can jacket can be formed in a shaping step at a shoulder-shaped contact area at the can bottom and fastened by a circumferential laser seam. By means of a heat treatment step, the plastic layer of the can bottom is connected to the inner layer of the can jacket within its contact area. For this purpose, the plastic layer of the can bottom comprises sealing material, when indicated, at least within the area of the desired connection. The heat treatment step is executed before the shaping step, if possible, so that the can bottom already adheres to the can jacket during shaping.

If it is wanted to dispense with the shaping of the can jacket at the can bottom after insertion, according to another preferred and—independently of the in the independent claims claimed invention, too—inventive embodiment, an annularly grooved receptacle area at the can jacket is formed for the corresponding contact area protruding to the outside of the can bottom. The can bottom should be pressed against the can jacket from the outside or from below, so that the contact area of the can bottom attains the receptacle area of the can jacket and is kept there. Now, a concave from the inside, circularly grooved area of the can bottom lies in a, from the inside, concave annularly grooved area of the can jacket. The front face of the can bottom lies on the inside of the can or on the inner can side and the front face of the can jacket on the outside of the can jacket or the outer can side.

At the free lower end of the can jacket, thus the can bottom, the cross section of the can jacket increases somewhat to the upper end and decreases afterwards. The lower decrease of the cross section has to be extremely small, so that the can bottom having a maximum outer diameter can be pressed into the inside of the can jacket. During pressing, the bowl area at the lower cross section constriction will elastically expand and/or the can bottom will slightly constrict at the maximum outer diameter. In case of the pressed can bottom, along the complete circumference, a shoulder of the can bottom engages the corresponding shoulder of the can jacket from the inside. In this shoulder area, the cross section of the free end of the can jacket decreases to an extent, that a stop is formed. The circumferential laser seam is circularly closed along the adjacently pressed shoulder areas. Behind the constricted shoulder area, the diameter of the can jacket increases again. From the outside, a groove-like depression is recognizable at the shoulder area of the can jacket and directly above.

It is advantageous, if the contact area of the can bottom is plugged into the inside of the can jacket. The dimension of the can bottom is usually chosen slightly larger than the dimension of the can jacket. Accordingly, the shoulder area of the can bottom is slightly more stable in shape than the shoulder area of the can jacket. An optimal pressure seat is attained by pressing the more stable shoulder area from the inside to the less stable shoulder area. The outer shoulder area is slightly stretched in circumferential direction, if indicated, the inner and more stable shoulder area is not deformed during this process or not compressed. If the can jacket would be on the inside and the more stable can bottom on the outside, force compression wrinkles could occur in the can jacket due to the pressure, which would inhibit a tight circumferential laser seam.

To guarantee a continuous inner coating at the transition from the can jacket to the can bottom, the can bottom is coated on the inside and furnished with meltable sealing bead. The can jacket is coated with a foil on the inside, wherein the shoulder area for the connection of the can bottom does not feature any coating. The can bottom does not contain any coating averting from the inside can on the outside at least in the shoulder area. The circumferential laser seam is now created between the directly adjacent metallic areas of can jacket and can bottom. To coat the front face of the can bottom on the inside of the can and the following uncoated area of the can jacket, the meltable sealing bead is heated up and lead to flowing and subsequent hardening, so that the material of the sealing bead creates a complete connection between the inner coatings of the can jacket and the can bottom.

To provide a protection layer on the bottom side of the can an outer bottom cover is fixed at the lower can end, preferably in form of a plastic bottom. If the bottom cover extends along the can wall from the can bottom, it can directly engage in the recessing groove over the circumferential laser seam. Thereby the bottom cover overlaps the lower front end of the can jacket and the circumferential laser seam. If the bottom cover is tightly connected to the can jacket at the recessing groove and the can wall comprises an outer foil, the metallic layer of the can jacket and the can bottom is tightly shut off against the outside and oxidation problems can be excluded. Since the bottom cover preferably spans the complete can bottom, it can be dispensed with a outer coating of the can bottom.

By means of the above described inventive embodiments a continuous inner coating of aerosol cans can be provided. Especially advantageous is the connection between the gasket ring in the valve seat and the inner coating of the can jacket and the inner coating of the connection bowl plus the plastic material along the circumferential laser seam between can bottom and can jacket and the inner coating of the can jacket and the inner coating of the can bottom. By means of two annular areas, which connect the different areas of inner coatings, it can be prevented that the product within the can comes into contact with the metallic layer of the can body and the product could leak out through minimal leakages in the circumferential laser seam.

The different handling steps can be carried out at turn tables, which is relatively sumptuous due to the synchronized handover and the holding and handover elements being adapted to the can diameter, though. The needed throughput capacities can be advantageously attained by embodiments in which several parallel linear handling lines are provided. In front of the single handling station storage areas can be provided, in which partly finished can bodies are fed to the parallel handling lines. If the production is switched from cans of a first diameter to cans of a second diameter, just few elements have to be adapted to the changed diameter with parallel handling lines.

By means of the inventive method steps it is possible to produce aerosol cans having extremely thin can jackets. For production of can jackets steel plates having a thickness of substantially only 0.16 mm can be used. If necessary, plates having a thickness of 0.16 mm and 0.12 mm can be used.

The figures illustrate the solution according to the invention by means of embodiments. Hereby illustrate

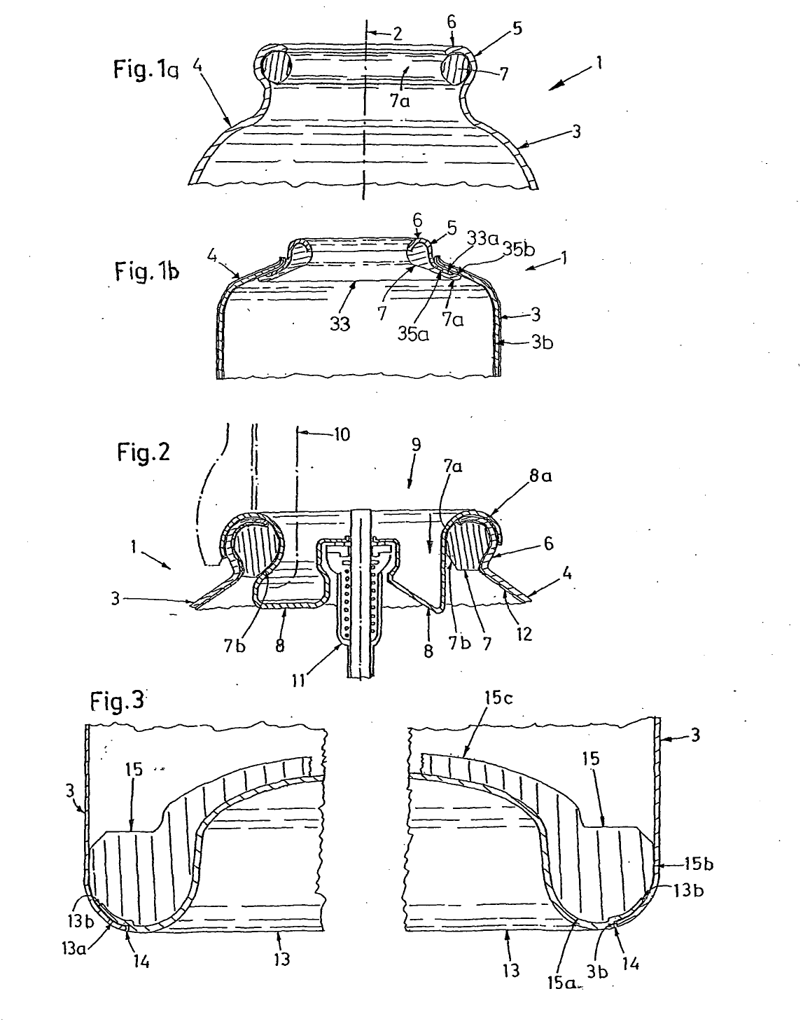

FIG. 1a a vertical section through the upper end of an aerosol can having a constriction and a valve seat;

FIG. 1b a vertical section through the upper end of an aerosol can having an attached valve seat;

FIG. 2 a vertical section through the upper end of an aerosol can having two situations (left, right) during attachment of a valve part;

FIG. 3 a vertical section through the lower end of an aerosol can;

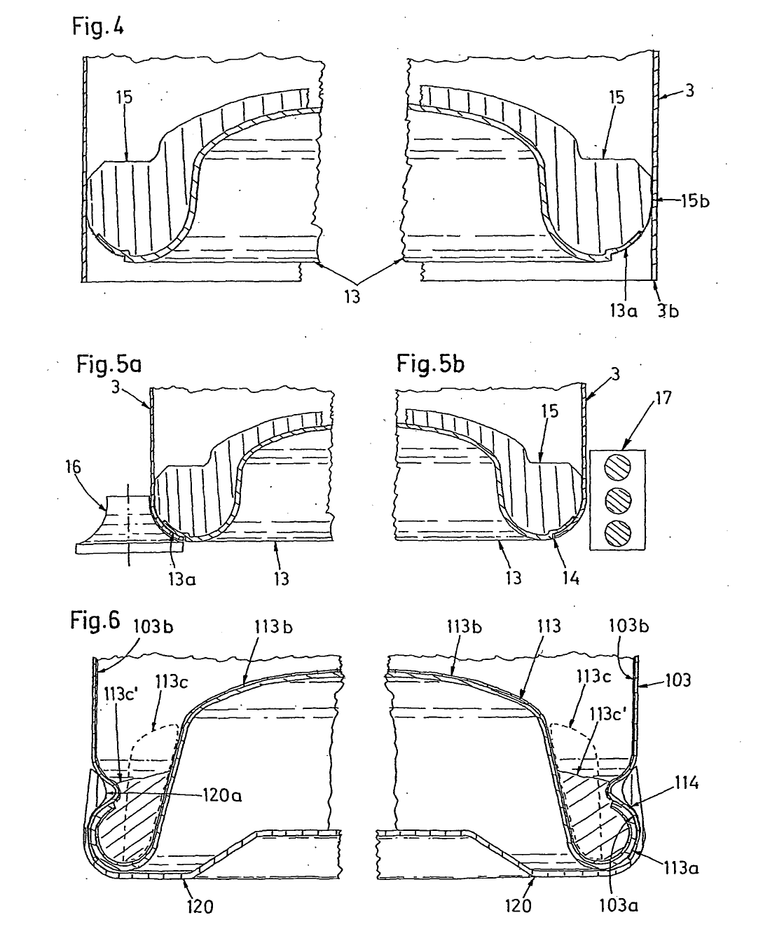

FIG. 4, 5a, 5b vertical sections through the lower end of an aerosol can during attachment of the can bottom;

FIG. 6 a vertical section through the lower end of an aerosol can with can bottom and outer bottom cover;

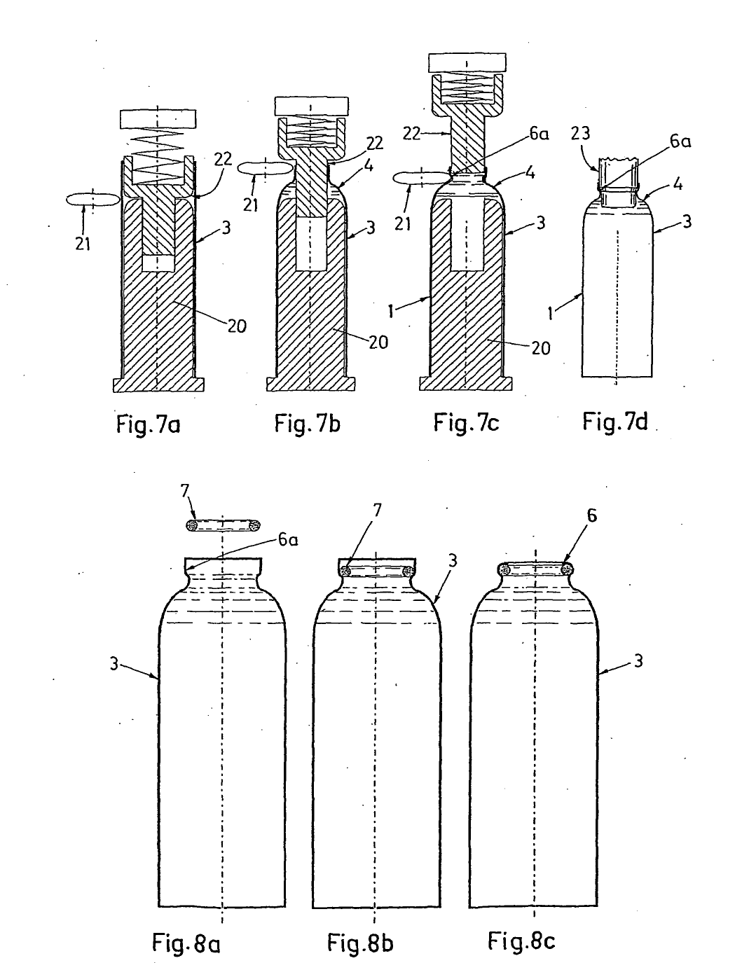

FIGS. 7a, 7b, 7c and 7d vertical sections through the can jacket and a constriction device during creation of a can neck with the valve seat;

FIGS. 8a, 8b and 8c vertical sections through the can jacket during insertion of the gasket ring;

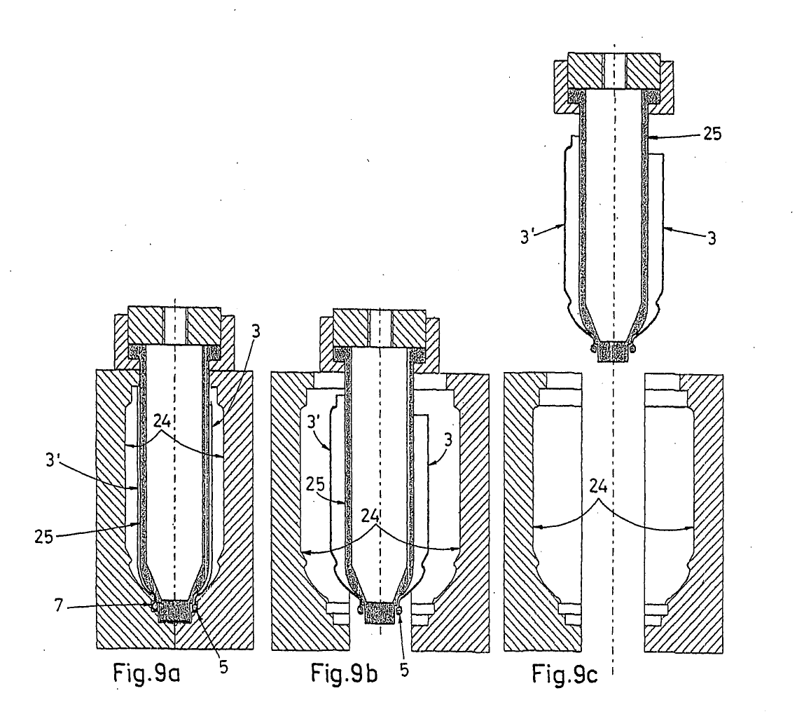

FIGS. 9a, 9b and 9c vertical sections through the can jacket and a shaping device during shaping of the can jacket;

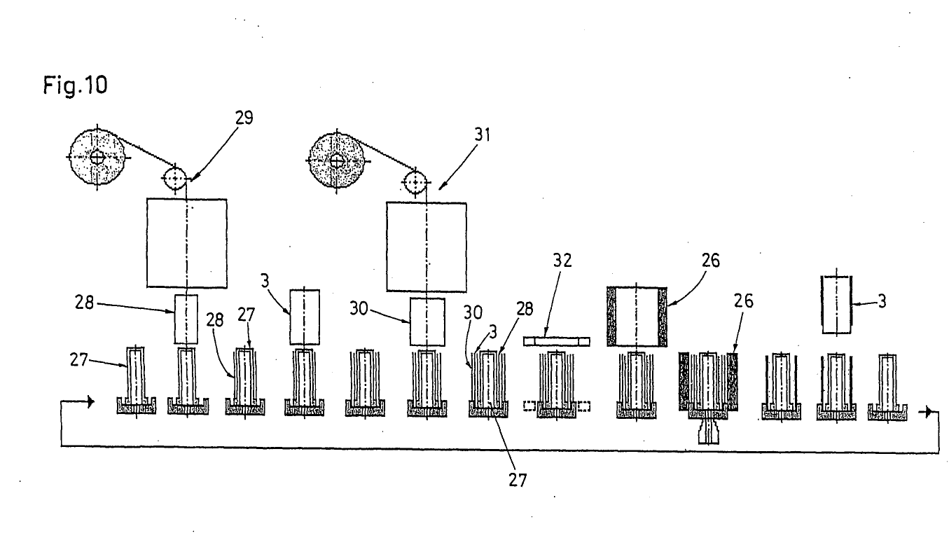

FIG. 10 a schematic sectional view of the inner and outer coating of a cylindrical jacket having an inner and an outer foil;

FIGS. 11a, 11b and 11c vertical sections through the connection of the upper connection part with the can jacket;

FIG. 11d a detail of a top view of the connection of the upper cover part and the can jacket;

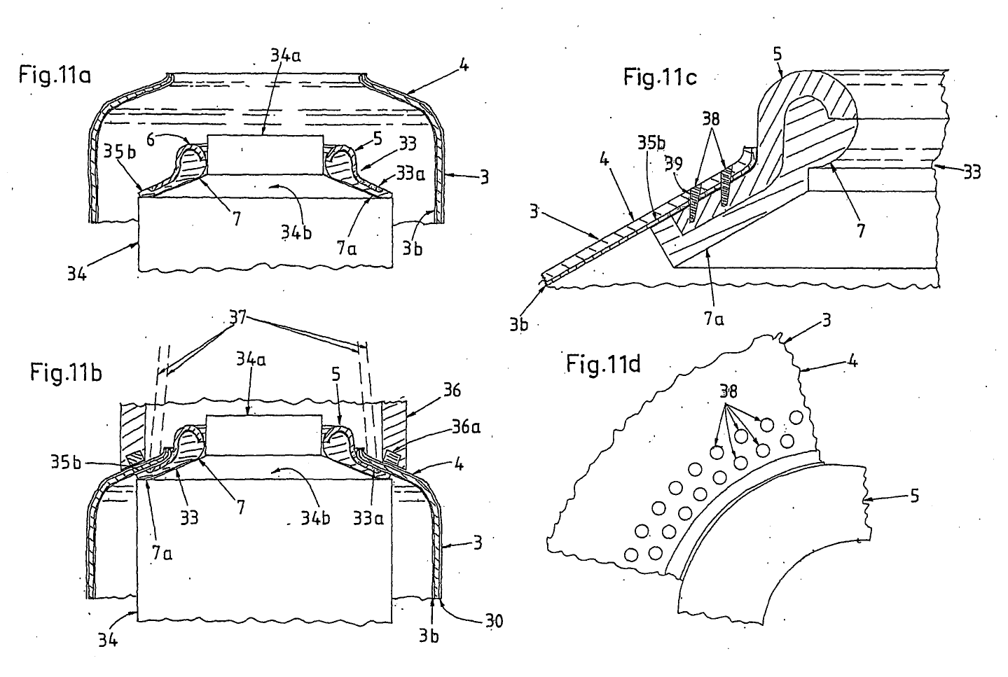

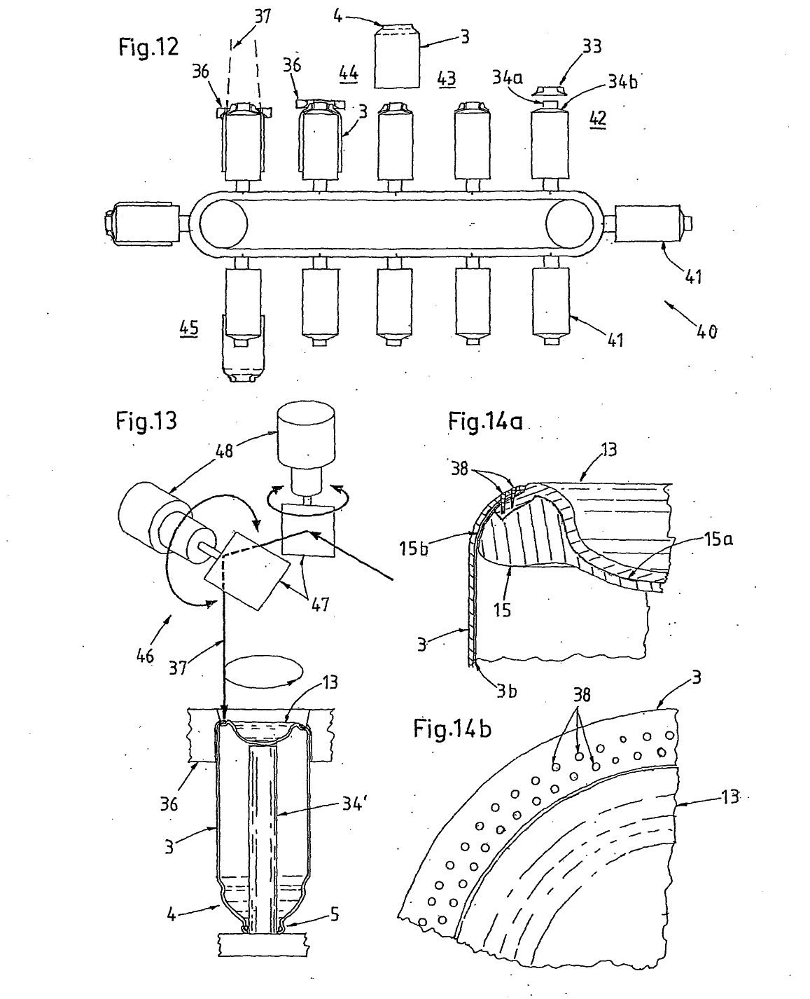

FIG. 12 a schematic illustration of a device to connect the upper cover part and the can jacket;

FIG. 13 a schematic illustration of a scan-laser device during creation of a circular laser connection;

FIG. 14a a vertical section through a detail of the connection of the can bottom and the can wall;

FIG. 14b a top view of a detail of the connection of the can bottom and the can wall

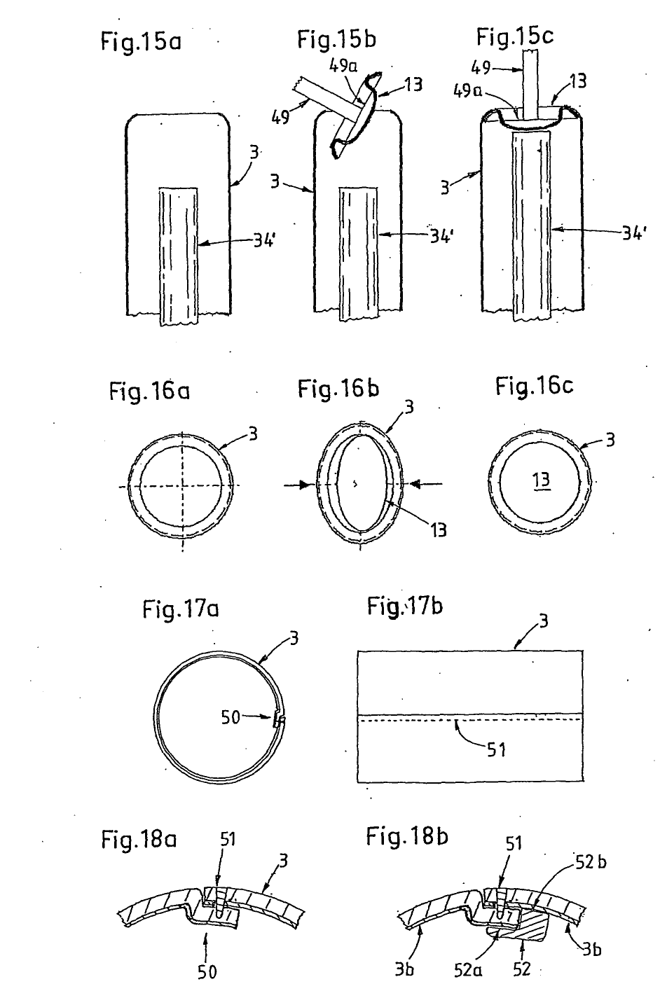

FIG. 15a, 15b, 15c vertical sections through can jacket and can bottom during insertion of the can bottom;

FIG. 16a, 16b, 16c schematic top views of the can jacket and the can bottom during insertion of the can bottom;

FIG. 17a a front face view of a can jacket produced from a plate by a laser connection;

FIG. 17b a side view of a can jacket produced from a plate by a laser connection and;

FIG. 18a, 18b enlarged details of vertical sections through the laser connection of the can jacket.

FIG. 1a shows the upper end of an aerosol can body 1 having a closed can jacket 3 around can axis 2, the cross section of which is constricted towards the upper end in an area with a can neck 4. At the free end of can neck 4, a valve seat 5 is created having a inward edge curl 6 and a gasket ring 7 inserted into the inward edge curl 6.

The gasket ring 7 is just retained by the inward edge curl 6 and is accessible along its complete circumference from the inside of the can body. The inward edge curl 6 is in a cross sectional plane, which comprises the can axis 2, formed open against the inside of the can body in a c-shaped way. In this open area the gasket ring 7 comprises a ring-shaped closed contact surface 7a.

FIG. 1b shows the upper end of an aerosol can 1 having an upper lid part 33 where the valve seat 5 and an inward edge curl 6 and a gasket ring 7 being inserted into the inward edge curl 6 are created. The can jacket 3 is constricted to form a can neck 4 at the upper end and consequently at the upper lid part 33. The upper lid part 33 has an accordingly formed overlap area 33a, which is welded by means of a laser connection at the constricted area of the can jacket 3. In the inside of the can along the circular laser connection, plastic material 7a is arranged which is tightly connected along an upper connection area 35a to the upper lid part 33 and along an outer connection area 35b to the can jacket 3. If on the inside of the can jacket 3 an inner coating or an inner foil 3b is arranged, the outer connection area 35b of the plastic material 7a is preferably tightly connected to the inner coating 3b by a heat treatment. The plastic material 7a can be implemented as a separate ring, preferably it is implemented as one piece with the gasket ring 7. On the outside of the can jacket 3 a outer foil 30 having a décor is arranged, if necessary.

FIG. 2 shows how the connection bowl 8 of a valve part 9 is put onto the valve seat 5 and is crimped to it. Centrally at the connection bowl 8, the valve 11 is arranged. At the right side, the valve part 9 is just put onto the valve seat 5 so that the contact area or the connection bowl curl 8a encompasses each the inward edge curl 6 and the gasket ring 7 partly. The connection bowl curl 8a engages the annularly closed contact area 7a of the gasket ring 7. After crimping, schematically illustrated on the left side, the connection bowl curl 8a even engages the gasket ring 7 in the area reaching from the smallest opening diameter of the gasket ring to the inside of the can or somewhat down. By this the contact face between gasket ring 7 and connection bowl curl 8a comprises an annularly closed inner part plane 7b.

The crimping tool 10, having inner and outer jaws, used for crimping presses the connection bowl curl 8a slightly around the gasket ring 7. Since the gasket ring 7 is elastic, the connection bowl curl 8a engages the gasket ring 7 along its complete circumference without any gap after crimping. The gasket ring 7 also engages tightly an inner contact face of the inward edge curl 6 of the can body 1. Since the front face or front plane of the inward edge curl 6 and thus of the can jacket 3, is enclosed by the gasket ring 7 and the connection bowl curl 8a, the product within the can is not able to reach the front face.

After filling and pressurizing inside the can, the inner pressure of the can acts on the gasket ring 7 via the connection bowl 8, too. The inner pressure increases the contact force between connection bowl 8 and gasket ring 7 or the inner part plane 7b. By the force acting on gasket ring 7, even the contact force between gasket ring 7 and inward edge curl 6 of the can body 1 is increased. The valve seat 5 having the gasket ring 7 which engages the connection bowl 8, enable a simply build, completely tight connection between can jacket 3 and valve part 9. The inner pressure does not involve the danger of leakage but increases tightness.

Corresponding to a preferred embodiment, can jacket 3 and connection bowl 8 of valve part 9 comprise a metal layer, especially an iron or steel plate, and on the inside of the can jacket and the connection bowl an inner layer of plastic. In FIG. 2 a can jacket inner layer 12 is illustrated. The plastic layers of can jacket 3 and connection bowl 8 extend below the gasket ring 7, so that an continuous inner coating even between can jacket 3 and connection bowl 8 is guaranteed, viewed from the can's inside. As already mentioned above the front face of the can jacket 3 is enclosed by the gasket ring 7 and the connection bowl curl 8a.

A connection from gasket ring 7 to the inner coatings of the can jacket 3 and the connection bowl 8 can be achieved at the contact surfaces by means of a small effort. As the case may be a superficial contact layer of the gasket ring 7 melts and connects to the inner coatings. If at the engaging contact faces a meltable plastic material is arranged, the engaging plastic contact surfaces melt due to the heat treatment. If a sealing coating is applied, it is advantageous to arrange it at the gasket ring 7. To create the sealing connection at the desired moment, which is after the right assembly of the components, preferably a hot sealing material is used and a heat treatment is conducted.

Corresponding to FIG. 3, the can jacket 3 is slightly constricted in a shoulder-shaped way at the can bottom 13. The can bottom 13 exhibits a correspondingly shaped overlap area 13a, which is welded to the constricted area of the can jacket 3 by a circumferential laser seam 14. On the inside of the can, plastic material 15 is arranged along the circular circumferential laser seam 14, which is tightly connected along a lower connection area 15a to the can bottom 13 and along an outer connection area 15b to the can jacket 3. The plastic material 15 can be laid onto the can bottom 13 as a ring or a plate having a ring-shaped edge, be sprayed on by means of a nozzle or even be build up by a injection molding step at the can bottom 13. If a central cover area 15c of the plastic material 15 covers the middle area of the can bottom 13, a can body 1, having a plastic layer over the complete inner face, can be produced with small effort.

The lower end area of can jacket 3 tightly engages the overlap area of the can bottom 13, being shoulder-shaped in cross section. The circumferential front face 13b of the can bottom 13 is located inside the can or at the inner can side respectively, and the lower front face 3b of the can jacket 3 outside of the can bottom 13. Preferably, the circumferential laser seam 14 is created directly at the lower front face or at the lower front plane 3b of can jacket 3.

If the circumferential laser seam 14 is placed directly at the front face of the can jacket 3, it can be guaranteed with small effort, that metallic areas, preferably without plastic coating, are allocated. The lower front face of the can jacket 3 is coating-free. The can bottom 13 can be shaped in a way that the front face of the can jacket 13 faces directly a step, so that the outer contour of the can body runs substantially step free at the transition of outer face of the can jacket 3 and outer face of the can bottom 13.

Within the minimal gap of the lower front face 3b of the can jacket 3 a metallic powder is filled in, if necessary, before laser welding. During laser welding, the metallic powder, the front face of the can jacket 3 and an engaging area of the can bottom 13 are shaped to form a connection seam. To avoid corrosion of the bottom, the bottom can be coated after creation of the circumferential laser seam or be covered by an outer bottom cover.

Starting from a cylindrical can jacket 3, it would be possible to constrict the lower end of the can jacket 3 first. The can bottom 13 would have to be inserted before creating the neck part from the upper end into the can jacket 3. Since the constriction of the neck part would then have to be performed having an inserted can bottom 13, this method is disadvantageous.

The FIGS. 4, 5a and 5b show different steps during the preferred connection of the can jacket 3 and the can bottom 13. The can bottom 13 is inserted from the lower front face of the can jacket 3 into the can jacket 3. If necessary, the outer connection area 15b is tightly connected to the can jacket 3 by a heat treatment step. But it is likewise functional, if this connection is created after the circumferential laser seam 14.

Corresponding to FIG. 5a a rolling process is preferably implemented for constricting the can jacket 3 after insertion of the can bottom 13. In doing so turning roll 16 is moved relatively to the can jacket 3 around its circumference. At the inserted and kept can bottom 13 and preferably at the form roll 16, too, the desired constriction contour for the constriction area of the can jacket 3 is created. During the rolling process the can jacket 3 is tightly pressed to the contact area 13a of the can bottom 13. By means of an optimal rolling method, the creation of wrinkles during constriction can be prevented. The wall material is slightly stretched in the direction of the can axis 2, so that no increase of the wall thickness in the constricted area is necessary. The constriction of the can jacket 3 by pressing against the shoulder-shaped contact area 13a of the can bottom 13 is without problems since the constriction needed for the connection is very small. The metallic layers of the can jacket 3 and the can bottom 13 are connected by the circumferential laser seam 14.

A ring-shaped, inductive heating device 17 is moved over the connection area to connect the outer connection area 15b to the inside of the can jacket 3 by the developing heat in the metallic layer of the can body 1. If the plastic material 15 is only laid onto the can bottom 13, a connection between the can bottom 13 and the lower connection area 15a can be attained by means of the inductive heating device 17. The plastic material 15 running along the circumferential laser seam 14 is then especially advantageous, if it covers the complete can bottom 13 and if the can jacket 3 exhibits an inner plastic layer.

FIG. 6 shows an alternative embodiment for arranging the can bottom 113. At the lower end of the can jacket 103 a can bottom 113, inserted from below, is welded, whereas, from the outside, a convex circular groove 113a of the can bottom 113 engages a concave circular groove 103a from the inside of the can jacket 103, and a circumferentially closed laser seam 114 is created in a shoulder area, wherein the cross section decreases from the lower end of the can jacket 103 to the upper side. Preferably, an outer bottom cover 120 is fixed at the lower front face of the can jacket 103, which covers the circumferential laser seam 114, the lower front face of the can jacket 103 and the can bottom 113. The outer bottom cover 120 can, for example, engage a corresponding circular groove of the can jacket 103 by a latch ring 120a. If necessary, the outer bottom cover 120 is sealed to the lower can end.

To guarantee a continuous inner coating at the transition from can jacket 103 to can bottom 113, the can bottom 113 is furnished with an inner bottom coating 113b and a meltable sealing bead 113c. The can jacket 103 is coated on the inside with an inner foil 103b, where the shoulder area for the connection to the can bottom 113 preferably does not have any coating. In turn, the can bottom 113 does not exhibit any coating on the outside, opposite of the can inside, at least in the shoulder area. The circumferential laser seam 114 is now created between directly engaging metallic areas of can jacket and can bottom. To coat the front face of the can bottom 113 inside the can and the adjoint uncoated area of the can jacket 103, the meltable sealing bead 113c is heated up and made flowing and afterwards solidified, so that the developing bottom sealing 113c′ generates a complete connection between inner coatings 103b, 113b of the can jacket 103 and the can bottom 113.

A can body 1 having an inward edge curl 6 and a retained gasket ring 7 is preferably produced from a cylindrical can jacket 3 by means of a intermittent longitudinal laser seam. FIGS. 7a, 7b, 7c and 7d show how neck part 4 is constricted by a spin-flow-necking-process. In the schematically illustrated method, the lower cylindrical area of the can jacket 3 is held on a rotary arbor 20. An outer constriction roll 21 is pressed to the rotating can jacket 3 to create the neck part 4 and, according to the corresponding insertion, is even pushed upwards. An upper guiding part 22 is moved upwards during constriction and enables the creation of an upper cylindrical end area. If necessary, the upper guiding part exhibits a lower end area in which a seat 6a—in form of a constriction—for the gasket ring 6 can be created. Tin accordance to FIG. 7a, the seat 6a can be created by inserting an expansion part 23.

Onto the constricted seat 6a, a gasket ring is laid, according to FIGS. 8a and 8b. Afterwards, as illustrated in FIG. 8c, the free end of the can neck is formed radially to the inside slightly around the gasket ring 7 to the inward edge curl 6.

Corresponding to FIGS. 9a, 9b and 9c, the valve seat 5 with the gasket ring 7 can be advantageously used to position a shorter or a longer can jacket 3, 3′ respectively, in a second inner mold 24. The second inner mold 24 corresponds to a desired end shape of the can jacket and comprises, for example, two form halves, which can be closed to from the can jacket 2, 3′ respectively, wherein the valve seat 5 is mounted into corresponding collets of the form halves. The second inner mold 24 can exhibit any forms and decor structures differing from the cylindrical form.

For pressing an elastic second pressure arbor 25, pressurizable by pressure fluid, is inserted into the can jacket 3 or 3′. The valve seat 5 and therewith the can jacket 3 is kept without sliding in axial direction during pressing. The valve seat 5 is not expanded. By keeping the can jacket 3 or 3′ at the valve seat 5, a defined position of the can jacket 3 or 3′ relative to the second inner mold 24 is guaranteed. Concerning the illustrated can jackets 3 and 3′ varying in length, the shorter one 3 is cylindrical down to the lower end, the longer one 3′ has a constricted area within the lower area. The constricted area can be created as a connecting area at the can bottom.

If, following the constricted area, a cylindrical jacket part is created at the free end of the can jacket 3′, it has to be cut off. To be able to abstain from cutting and thereby from an additional effort, the height of the wall material for the can jacket has been chosen in a way that the constricted area reaches to the free end after pressing.

FIG. 10 schematically illustrates a facility by means of which an inner and/or outer foil can be attached to the closed cylindrical bowl made from metal sheet. For this purpose, at least one elastic, with pressure fluid pressurizable, pressure arbor 27 and a first inner mold 26 is used. To be able to bring the layers of the can jacket 3 together with small effort, the consolidation is preferably carried out by just one pressure arbor and one inner mold. The inner foil 28 is closed by a first feeding device 29 to form a cylindrical jacket, and is put onto the pressure arbor 27, so that it is tightly enclosed. Afterwards, the metallic can jacket 3 is put on, which now encloses the inner foil 28. At last, the outer foil 30 is closed by a second feeding device 31 to from a cylindrical jacket and put on the metallic can jacket 3 from the outside, so that it is enclosed. It comes without saying that, if necessary, even only the inner foil 28 or only the outer foil 30 can be applied.

By means of an inductive heating device 32, the metallic can jacket 3 is slightly warmed up, and directly afterwards the first pressure arbor 27 and the adjacent layers on the inside of the cylindrical first inner mold 26 are stretched radially to the outside. To attain a pressing from the middle against both front faces, a barrel-shaped pressure arbor 27 can be used, which firstly presses in the middle area during pressurizing. During pressing against the inner mold, the circumference of all layers of the can jacket 3 is slightly increased. To ensure a durable adhesion of foils 28, 30 to the metallic layer, foils 28, 30 having a sealing layer, which faces the metallic layer, are used. In case of a hot sealing layer the desired sealing is attained by conveying heat to the layers of the can jacket, particularly contact heat of the pre-heated metallic can body.

The layers composed by means of sealing connections of the cylindrical can jacket 3 adhere in such a good way, that the constriction method illustrated by FIGS. 7a to 7d can be carried out.

FIGS. 11a, 11b, 11c and 11d show the upper constricted end, forming a neck part 4, of a can jacket 3, being held by a retaining unit not shown. On the inside of the can jacket 3, an inner foil 3b and on the outside an outer foil 30 or an outer coating is arranged. From below, a retaining arbor 34 lifts the upper lid part 33 against the upper opening of the can jacket 3. The upper lid part 33 comprises the valve seat 5 having an inward edge curl 6 and the gasket ring 7 being positioned within the inward edge curl 6. To guarantee a precise positioning and pressing of the upper lid part 33 to the neck part 4, the retaining arbor 34 comprises a gauge lug 34a and a pressure plane 34b. The upper lid part 33 is pressed to the corresponding plane of the neck part 4 by transition area 33a adapted to the constriction of the can jacket 3

To connect the upper lid part 33 in a solid and tight manner to the can jacket 3, an upper pressure ring 36 is attached to the neck part 4 from above. A heating device 36a is created and arranged in a way that heat can be conveyed to the outer connection area 35b of the plastic material 7a, whereby a hot sealing connection between upper connection area 35b of the plastic material 7a and inner foil 3b is created. If the plastic material 7a is formed as one part together with the gasket ring 7, a continuous inner coating from inner foil 3b to gasket ring 7 is generated.

By means of a scanner laser beam 37 a metallic layer of the can jacket 3 is connected to a metallic layer of the upper lid part 33 within the overlap area 33a. Within the overlap area 33a, the evolving laser connection comprises a plurality of narrow connection spots 38, in which the laser beam fused both metallic layers together. It has been shown that the material of the inner foil 3b evades from the center of the laser beam during the point-shaped application of laser energy and both metallic layers interconnect without disturbance via the fused, in a bolt-shaped way, and solidified melting areas 39.

Time and power, with which the laser beam creates a connection spot 38, are chosen in a way that the melting area 39 does not completely pass through the metallic layer of the upper lid part 33 and the plastic layer 7a is not affected. Different patterns and, if necessary, different cross sections of connection spots are possible, whereas at least one line along the circumference is necessary. By the control of the scan laser, the arrangement and form of the connection areas or the connection spots can be changed with small effort.

FIG. 12 illustrates an embodiment of a device for connecting the upper lid part and the can jacket. Protruding retaining arbors 34, having a gauge lug 34a and a pressure plane, are fixed to a circumferential chain or belt device 40, wherein several lines of retaining arbors 34 can be arranged in parallel to furnish several can jackets 3 with upper lid parts 33 in parallel. Within a first feeding area 42, upper lid parts 33 are put onto retaining arbors 34. Within a second feeding area 43, can jackets 3 are put on the retaining arbors 34 via the upper lid parts 33.

An upper pressure ring 36 is put to the neck part 4 of the can jacket 3 from above and attains a sealing connection of connection area 35b of the plastic material 7a and the inner foil of the can jacket 3 by means of a heating device. Afterwards, a metallic layer of the can jacket 3 is connected to a metallic layer of the upper lid part 33 by means of a scanner laser beam 37. Since neither the can parts nor the laser source have to be revolved, the laser connection facility can be build up in a simple way. Within the hand-over area 45 the can jacket 3 with the upper lid part 33 is delivered for transportation to another can treating station.

FIG. 13 illustrates a scanner laser device 46, which creates a laser connection along a circular line by the scanner laser beam 37, having a plurality of narrow areas, in which the laser beam fused two metallic layers together. Within the illustrated treating step a can bottom 13 is pressed to the lower constriction of the can jacket 3 from the inside and fixed by the laser connection. Within the can a retaining arbor 34′ presses the can bottom 13 against the constriction of the can jacket 3, wherein the can jacket 3 is retained by the pressure ring 36 against the can bottom 13.

The scanner laser beam 37 reaches from a laser source not shown via two pivotable mirrors 47 or reflection planes, pivotal about two orthogonal axes, to the circular area, in which the laser connection has to be created. A control, which his not illustrated, and two actuators 48 actuate the rotary adjustment of both mirrors 47.

It comes without saying that by means of the scanner laser device 46 even a different lid element can be attached to the can jacket 3 instead of the can bottom. Moreover, the lid element could even be placed on the outside on the front face of the can jacket. Thereby, this embodiment is not limited to aerosol cans and of course not to special aerosol cans having an inward edge curl.

FIGS. 14a and 14b illustrate a laser connection produced by a scanner laser device 46. It comprises a plurality of narrow connection spots 38 within the overlap area of the connected parts, in which the laser beam fused both metallic layers together. It has been shown that the material of the inner foil 3b more away from the center of the laser beam during the point-shaped application of laser energy and both metallic layers interconnect without disturbance via the fused, in a bolt-shaped way, and solidified melting areas 39. Different patterns of connection spots are possible, whereas at least one line along the circumference is necessary. By the control of the scan laser the arrangement and form of the connection areas or the connection spots can be changed with small effort.

FIGS. 15a, 15b and 15c as well as 16a, 16b and 16c show the insertion of a can bottom 13 through the constricted end area of can jacket 3. If the can jacket 3 is slightly constricted at the end area where the can bottom 13 is arranged, the can bottom 13 has a slightly larger outer radius than the passage opening of the constricted area.

In FIGS. 15b and 16b, the cross section of can jacket 3 is reshaped to an oval cross section by a small pressure or by squeezing. Thereby, the opening cross section increases in a first direction and decreases in the orthogonal second direction. The can bottom 13 is held by a insertion mount 49, wherein preferably a depression is created at a suction contact area 49a for holding. During insertion, the can bottom 13 is slightly tilted by the insertion mount 49 to the plane of the oval opening, which substantially runs parallel to the first direction.

In its tilted position the can bottom 13 is inserted into the can jacket 3.

FIGS. 15c and 16c illustrate a situation after back tilting the can bottom 13 by vertically adjusting the insertion mount 49. To further press the can bottom 13 against the constriction from the inside after removing the insertion mount 49, the upper front face of the retaining arbor 34′ is pressed against the can bottom. Within the overlap area, the can bottom 13 can be attached to the can jacket 3 by a laser connection.

The novel and inventive laser connection having a plurality of narrow spots, where the laser beam fused both metallic layers together can—independently from the claimed invention in the independent claims, too—not only be advantageously used for connecting a lid part and a can jacket 3. With the help of FIGS. 17a, 17b and 18a, 18b, a can jacket 3 produced from a plate by a laser connection. The plate is formed to a pipe, wherein both adjacent areas on the side lie overlapping against each other within an overlap area 50 along the laser connection.

By means of a laser, a laser connection 51 is created within the tightly engaging lateral areas, wherein this connection is composed of a plurality of narrow connection spots. Thereby, the can jacket 3 can be moved relatively to the laser outlet port, or the impact spot of the laser beam 37 can be moved along the overlap area 50.

In case that the interior of the can jacket 3 has not to be separated completely from the metallic layer of the can jacket, a connection corresponding to FIG. 18a suffices, wherein a inner front face of the metallic can jacket layer is accessible from the inside of the can.

To ensure a complete inner coating, an inner foil 3b or a plastic coating is arranged at the metallic layer of the plate for the can jacket 3, and a plastic bead 52 is arranged at the first front face, which lies within the inside of the can jacket 3. A first connection plane 52a of the plastic bead 52 is connected directly to the inner foil by an adhesive bond or sealing connection or to the coating at the first front face. After forming of the can jacket, a second connection plane 52b of the plastic bead 52 lies against the inner foil 3b in the vicinity of the second front face of the metallic layer of the plate. By means of a sealing or adhesive bond connection, even the second connection plane 52b is tightly connected to the inner foil 3b or the coating. Can jackets having this connection can be advantageously applied in production of any type of three-part cans. Three-part cans having a can jacket, which exhibits a longitudinal laser connection 51 having a plurality of narrow connection spots and a plastic bead 52 being tightly connected to the inner foil 3b or coating, can be produced with high quality in a simple way.

1. An aerosol-can body, comprising:
a closed can jacket around a can axis;
a constricted can neck; and
a valve seat formed at a free end of the can neck by a inward edge curl, the valve seat including a gasket ring retained within the inward edge curl, the gasket ring being kept only by the inward edge curl and being accessible from inside of the can body along a complete circumference of the can body.

2. An aerosol-can body according to claim 1, wherein the inward edge curl is formed openly c-shaped towards the inside of the can body in a cross sectional plane including the can axis, and wherein the cross section of the gasket ring is fitted to an inner shape of the inward edge curl.

3. An aerosol-can body according to claim 1, wherein the can jacket is formed by a radially expanding pressure step to a second inner mold, and wherein the valve seat is only retained within the second inner mold and is not expanded.

4. An aerosol-can body according to claim 1, wherein the valve seat is crimped a connection bowl including a valve, and wherein the inward edge curl and the gasket ring are partly encompassed by a connection bowl curl, and between connection bowl curl and gasket ring a circularly closed contact surface is created, which at least includes a circularly closed inner partial surface within an area beginning from a relatively smallest opening cross section of the gasket ring to the inside of the can.

5. An aerosol-can body according to claim 1, wherein the can jacket and the connection bowl include a layer of metal, wherein, an inner layer from plastic is arranged on the inside of the can jacket and the connection bowl, and wherein the plastic layer of the can jacket and the connection bowl extend to the gasket ring, so that even within the connection area between can jacket and connection bowl, a continuous inner coating is guaranteed.

6. An aerosol-can body according to claim 5, wherein the metal layer of the can jacket is closed in a circumferential direction by a butted longitudinal laser seam and the plastic layer on the inside of the can jacket is formed by a inner foil of plastic material.

7. An aerosol can body according to claim 1, wherein to the lower end of the can jacket averted from the valve seat, a can bottom is welded by a laser connection, wherein on the inside of the can plastic material, which is tightly connected to the can bottom and the can jacket, is arranged along the complete circular laser connection, wherein the lower end area of the can jacket engages closely the shoulder-shaped contact area of the can bottom in vertical section, and wherein the circumferential front face of the can bottom is located within the can or on the inside of the can jacket, while the lower front face of the can jacket is sited on the outside of the can bottom.

8. An aerosol can body according the claim 1, wherein the valve seat is formed at an upper lid part, wherein the upper lid part is attached to the can jacket by a laser connection and wherein plastic material is arranged on the inside at the laser connection, which guarantees a tight connection with the inner foil of the can jacket and with the gasket ring.

9. A method for production of an aerosol-can body including a can jacket closed around a can axis and a valve seat, said method providing a constricted can neck at a front face of the can body, the method comprising:
creating a inward edge curl at a free end of the can neck; and
inserting, into the inward edge curl, a gasket ring, the gasket ring being only retained by the inward edge curl and being accessible from inside of the can body along a complete circumference of the can body.

10. A method according to claim 9, wherein, during creation of the can neck, a cylindrical area having a constricted inner seat for the gasket ring is provided at its constricted end, the gasket ring being inserted to the seat through the cylindrical area, and wherein the free end of the can neck is formed radially to the inside slightly around the gasket ring.

11. A method according to claim 9, wherein, during production of the can jacket, a metal plate is closed in circumferential direction of the can jacket by a butted longitudinal laser seam to form a cylindrical can jacket, and is arranged together with at least one of a cylindrical inner foil and an outer foil onto a pressure arbor, the first pressure arbor being expanded radially to the outside with the metallic can jacket, put on, and the at least one adjacent foil of the can jacket on the inside of the cylindrical first inner mould, so that the circumferences of all layers of the can jacket are slightly increased to attain a durable connection between the at least one foil and the metallic can jacket including at least one foil of the sealing layer facing the metallic layer, and in a sealing step is formed to a sealing connection by heat input and pressing from the at least one foil to the metallic layer of the can jacket.

12. A method according to claim 11, wherein the can neck is created with the valve seat either at the free end of the cylindrical can jacket by a constriction step, wherein the can jacket is revolved around the can axis during constriction, a constriction tool is pressed against the can wall from outside and moved into the direction of the can axis, or the valve seat is created at an upper lid part, and wherein the upper lid part is attached to the can jacket by a laser connection and plastic material is arranged on the inside at the laser connection, which guarantees a tight connection to an inner foil of the can jacket and to the gasket ring.

13. A method according to claim 9, wherein the can jacket is shaped by a second radially expanding pressing step at a second inner mold, and wherein the valve seat is retained only during pressing into the second inner mould and is not expanded.

14. A method according to claim 9, wherein a can bottom is inserted into the inside of the can jacket at the lower end of the can jacket, the end area of the can jacket is tightly pressed to the in cross section shoulder-shaped contact area of the can bottom, and the can bottom is attached at the shoulder-shaped contact area by a circularly closed laser connection, and wherein plastic material is arranged on the inside of the can along the circular laser connection, which is tightly connected to the can bottom and the can jacket.

15. A device for producing of an aerosol can body including a can jacket closed around a can axis and a valve seat, said device providing a constricted can neck and an inward edge curl at the free end of the can neck, a gasket ring being inserted into the inward edge curl at the produced aerosol can body, the gasket ring being retained only by the inward edge curl and being accessible along its complete circumference from the inside of the can body, the device comprising one of:
a) valve seat including at least one device to create a cylindrical area at the can neck with a constricted inner seat at the can jacket, the gasket ring being insertable into the valve seat, a free end of the can jacket being formed radially to an inside slightly around the gasket ring, or
b) a connection device to connect an upper lid part, including an inward edge curl and the gasket ring, to the can jacket, wherein the connection device includes a laser connection device, to enable creation of a plurality of narrow connection spots, created by a laser beam, and includes a sealing device to tightly connect plastic material at the upper lid part to a inner foil of the can jacket.

16. An aerosol-can body according to claim 2, wherein the can jacket is formed by a radially expanding pressure step to a second inner mold, and wherein the valve seat is only retained within the second inner mold and is not expanded.

17. An aerosol-can body according to claim 2, wherein to the valve seat is crimped a connection bowl including a valve, and wherein the inward edge curl and the gasket ring are partly encompassed by a connection bowl curl, and between connection bowl curl and gasket ring a circularly closed contact surface is created, which at least includes a circularly closed inner partial surface within an area beginning from a relatively smallest opening cross section of the gasket ring to the inside of the can.

18. An aerosol-can body according to claim 5, wherein the can jacket and the connection bowl include an iron sheet.

19. An aerosol-can body according to claim 5, wherein the gasket ring features a smelt or sealing connection to at least one adjacent plastic layer.

20. A method according to claim 10, wherein, during production of the can jacket, a metal plate is closed in circumferential direction of the can jacket by a butted longitudinal laser seam to form a cylindrical can jacket, and is arranged together with at least one of a cylindrical inner foil and an outer foil onto a pressure arbor, the first pressure arbor being expanded radially to the outside with the metallic can jacket, put on, and the at least one adjacent foil of the can jacket on the inside of the cylindrical first inner mould, so that the circumferences of all layers of the can jacket are slightly increased to attain a durable connection between the at least one foil and the metallic can jacket including at least one foil of the sealing layer facing the metallic layer, and in a sealing step is formed to a sealing connection by heat input and pressing from the at least one foil to the metallic layer of the can jacket.
